(19) United States
(12) Patent Application Publication
(10) Pub. No.: US 2025/0243077 A1
(43) Pub. Date: Jul. 31, 2025

(54) METHODS AND SYSTEMS FOR STRONTIUM IMPURITY EXTRACTION

(71) Applicant: Zeno Power Systems, Inc., Washington, DC (US)

(72) Inventors: Christofer Eryn WHITING, Cleveland, OH (US); Olivera ZIVKOVIC, Washington, DC (US); Sean WEDDELL, Seattle, WA (US); Ted A. BAUGHMAN, Redmond, WA (US)

(73) Assignee: Zeno Power Systems, Inc., Washington, DC (US)

(21) Appl. No.: 19/036,967

(22) Filed: Jan. 24, 2025

Related U.S. Application Data
(60) Provisional application No. 63/625,756, filed on Jan. 26, 2024.

(51) Int. Cl. C01F 11/22; C01G 25/02; C01G 25/04

(52) U.S. Cl. CPC C01F 11/22; C01G 25/02; C01G 25/04

(57) ABSTRACT

Provided herein are methods and systems for extracting zirconium and/or other impurities from a strontium-containing mixture. A method for removing zirconium from a mixture including zirconium and strontium can include converting at least a portion of a Zr-containing precursor to ZrF₄ in the mixture, converting at least a portion of a Sr-containing precursor to SrF₂ in the mixture, solubilizing at least a portion of the ZrF₄ and/or the SrF₂ in a solvent to create a solution, and/or separating at least a portion of the solubilized ZrF₄ and/or at least a portion of the solubilized SrF₂ from the mixture.

### CROSS-REFERENCE TO RELATED APPLICATIONS

This application claims the benefit of U.S. Provisional Application No. 63/625,756 filed Jan. 26, 2024, the entire contents of which are hereby incorporated by reference.

### FIELD

The present disclosure relates generally to methods and systems for processing strontium (Sr), and more specifically to methods and systems for removing zirconium (Zr) and other metals from a mixture comprising Zr and Sr.

### BACKGROUND

Sr-90 nuclide is a pure beta-emitting radionuclide with a half-life of 28.8 years. It decays to the Y-90 nuclide and finally stabilizes to the Zr-90 nuclide through beta decay. Owing to its high decay heat, Sr-90 has been utilized as a heat source or fuel for radioisotope power systems, such as radioisotope thermoelectric generators, radioisotope heater units, and radioisotope Stirling generators. However, the sources of Sr-90 contain Zr as a decay product after a long decay time-typically at least 5 years. The Zr metal does not contribute to the heat production of the heat source and just reduces the power density and specific power of the radioisotope heat source. The impurity Zr can exist in multiple forms, including metallic or elemental zirconium (Zr), and zirconium fluorides: zirconium difluoride (ZrF₂), zirconium trifluoride (ZrF₃), zirconium tetrafluoride (ZrF₄), and zirconium oxide (ZrO₂), and zirconium oxy fluoride (ZrOF₂). To obtain high-purity Sr suitable for practical applications, particularly in radioisotope power systems, these Zr-containing impurities should be removed. However, efficient impurity extraction methods and systems for removing Zr from Sr have rarely been investigated and remain unmet.

### SUMMARY

Provided herein are systems and methods for removing zirconium from a mixture comprising zirconium and strontium. As discussed above, Sr-90 can be used as a heat source or fuel for radioisotope power systems. However, Sr-90 sources often include the impurity zirconium (e.g., as elemental Zr, a salt of Zr, and/or an oxide of Zr). Using the systems and methods described herein, zirconium can be removed from mixtures containing zirconium and strontium in order to produce high-purity strontium compounds.

A method for removing zirconium from a mixture including zirconium and strontium can include converting at least a portion of a zirconium-containing precursor to ZrF₄ in the mixture. The zirconium-containing precursor may be elemental zirconium (Zr), a salt of Zr, an oxide of Zr, or combinations thereof, and the strontium (Sr) may be elemental Sr, a salt of Sr, an oxide of Sr, or combinations thereof. At least a portion of the ZrF₄ can be solubilized in a solvent to create a solution. At least a portion of the solubilized ZrF₄ can then be separated from the mixture.

Alternatively, other methods may be used to remove zirconium from a mixture including zirconium and strontium. For example, zirconium can be removed from a mixture including zirconium and strontium using sublimation. A zirconium-containing precursor (e.g., elemental Zr, a salt of Zr, and/or an oxide of Zr) can be converted to ZrF₄ and/or ZrCl₄ in the mixture. At least a portion of the ZrF₄ and/or ZrCl₄ can then be sublimed from the mixture. As another example, zirconium can be removed from a mixture including zirconium and strontium by melting at least a portion of the mixture and subsequently separating zirconium-containing components and strontium-containing components using centrifugation and/or filtration. In another example, zirconium can be removed from a mixture including zirconium and strontium using ion exchange techniques.

Similar techniques may also be used to remove strontium from a mixture including zirconium and strontium. A method for removing strontium from a mixture can include converting at least a portion of a strontium-containing precursor (e.g., elemental Sr, a salt of Sr, and/or an oxide of Sr) to SrF₂ in the mixture. At least a portion of the SrF₂ can be solubilized in a solvent to create a solution. At least a portion of the solubilized SrF₂ can then be separated from the mixture. Alternative techniques such as sublimation, melting, and ion exchange can also be used to remove strontium from a mixture including zirconium and strontium.

The systems and methods described herein may also be used to remove other materials from mixtures including Zr and Sr, such as aluminum, barium, calcium, cadmium, cobalt, chromium, cesium, copper, iron, potassium, magnesium, manganese, sodium, neodymium, nickel, lead, yttrium, silicon, and carbon.

An exemplary method for removing zirconium from a mixture comprising zirconium and strontium comprises: converting at least a portion of a zirconium-containing precursor to ZrF₄ in the mixture; solubilizing at least a portion of the ZrF₄ in a solvent to create a solution; and separating at least a portion of the solubilized ZrF₄ from the mixture.

In some embodiments, the zirconium-containing precursor may be elemental zirconium, a salt of zirconium, or an oxide of zirconium. In some embodiments, the method further includes converting at least a portion of a strontium-containing precursor in the mixture to SrF₂. In some embodiments, the strontium-containing precursor may be elemental strontium, a salt of strontium, or an oxide of strontium. In some embodiments, the solvent comprises water and the solution is an aqueous solution. In some embodiments, the solubilization of at least a portion of the ZrF₄ comprises adding at least one solubility amplifier to the mixture to increase the solubility differences between ZrF₄ and SrF₂ in water. In some embodiments, the solubility amplifier comprises NaF, KF, or a combination thereof. In some embodiments, the portion of the solubilized ZrF₄ is separated from the mixture by filtration. In some embodiments, the solubility amplifier comprises a base. In some embodiments, the solubility amplifier comprises NaOH, KOH, NH₄OH, or any combination thereof.

In some embodiments, the method comprises: solubilizing at least a portion of SrF₂ in an organic solvent to create an organic solution; and separating at least a portion of the solubilized ZrF₄ from the organic solution.

In some embodiments, the organic solvent comprises halogenated organic solvent. In some embodiments, the halogenated organic solvent comprise trichloroethylene (TCE).

In some embodiments, the mixture comprises ZrO₂. In some embodiments, the mixture comprises ZrF₄. In some embodiments, the mixture comprises elemental Zr. In some embodiments, the conversion of at least a portion of the elemental Zr, the salt of Zr, or oxide of Zr to ZrF₄ in the mixture comprises reacting the elemental Zr, the salt of Zr, or oxide of Zr with a fluorinating agent. In some embodiments, the fluorinating agent comprises fluorine gas (F₂), hydrofluoric acid (HF), ammonium bifluoride (NH₄HF), ammonium fluoride (NH₄F), or any combination thereof.

In some embodiments, the mixture comprises strontium hexaboride SrB₆. In some embodiments, the mixture comprises SrTiO₃, Sr(NO₃)₂, SrSO₄, or SrCO₃. In some embodiments, the mixture comprises elemental Sr. In some embodiments, the mixture comprises SrF₂. In some embodiments, the conversion of at least a portion of the elemental Sr, the salt of Sr, or oxide of Sr to SrF₂ in the mixture comprises reacting the elemental Sr, the salt of Sr, or oxide of Sr with a fluorinating agent. In some embodiments, the fluorinating agent comprises sodium fluoride (NaF), potassium fluoride (KF), fluorine gas (F₂), hydrofluoric acid (HF), ammonium bifluoride (NH₄HF), ammonium fluoride (NH₄F), or any combination thereof. In some embodiments, the method comprises converting at least portion of elemental Sr, or an oxide of Sr to SrCO₃, and converting the SrCO₃ to SrF₂.

In some embodiments, the mixture comprises ZrO₂, and the method comprises converting at least a portion of the elemental Strontium (Sr), the salt of Sr, or an oxide of Sr to SrF₂ in the mixture, and separating at least a portion of the ZrO₂ from the mixture.

An exemplary method for removing zirconium from a mixture comprising zirconium and strontium comprises: converting a zirconium-containing precursor to ZrF₄ or ZrCl₄ in the mixture; and subliming at least a portion of the ZrF₄ or ZrCl₄ from the mixture.

In some embodiments, the zirconium-containing precursor may be elemental zirconium (Zr), a salt of Zr, or an oxide of Zr. In some embodiments, the method comprises converting the elemental Zr, the salt of Zr or oxide of Zr to ZrCl₄. In some embodiments, the method comprises converting Zr oxide to ZrCl₄. In some embodiments, the conversion of Zr oxide to ZrCl₄ comprises reacting Zr oxide with CCl₄ at an elevated temperature of about 350° C. to about 600° C.

In some embodiments, the method comprises converting the elemental Zr, the salt of Zr or oxide of Zr to ZrF₄ and then converting ZrF₄ to ZrCl₄. In some embodiments, the conversion of ZrF₄ to ZrCl₄ comprises reacting ZrF₄ with a mixture of FeCl₃ and KCl. In some embodiments, the conversion of elemental Zirconium (Zr), the salt of Zr or oxide of Zr to ZrF₄ comprises converting elemental Zr to ZrCl₄. In some embodiments, conversion of Zr to ZrCl₄ comprises reacting Zr with a mixture of FeCl₃ and KCl. In some embodiments, the sublimation of a portion of the of ZrF₄ or ZrCl₄ is carried out at a temperature from about 250° C. to about 900° C. In some embodiments, the sublimation is carried out at a temperature from about 300° C. to about 400° C. In some embodiments, the sublimation is carried out under a pressure lower than ambient temperature. In some embodiments, the sublimation is carried out under a pressure less than 10 psi.

An exemplary method for removing strontium (Sr) from a mixture comprising zirconium (Zr) and Sr comprises: solubilizing at least a portion of SrF₂ in a solvent to create a solution; and/or separating at least a portion of the solubilized SrF₂ from the mixture.

In some embodiments, the method comprises converting at least a portion of an Sr-containing precursor to SrF₂ in the mixture prior to solubilizing the at least a portion of the SrF₂. In some embodiments, the Sr-containing precursor comprises elemental strontium, a salt of strontium, or an oxide of strontium. In some embodiments, the method comprises converting at least a portion of a Zr-containing precursor in the mixture to ZrF4. In some embodiments, the Zr-containing precursor comprises elemental zirconium, a salt of zirconium, or an oxide of zirconium.

In some embodiments, the method includes converting the solubilized SrF₂ to a Sr-containing solid (e.g., strontium carbonate). In some embodiments, converting the solubilized SrF₂ to the Sr-containing solid comprises treating the solubilized SrF₂ with ammonium carbonate, sodium carbonate, and/or potassium carbonate. In some embodiments, the method includes removing the Sr-containing solid from remaining solubilized materials.

In some embodiments, converting at least a portion of the Sr-containing precursor in the mixture to SrF2 comprises reacting the Sr-containing precursor with a fluorinating agent. In some embodiments, the fluorinating agent comprises sodium fluoride (NaF), potassium fluoride (KF), fluorine gas (F2), hydrofluoric acid (HF), ammonium bifluoride (NH4HF), ammonium fluoride (NH4F), or any combination thereof. In some embodiments, the method comprises converting at least portion of the Sr-containing precursor to SrCO3, and converting the SrCO3 to SrF2.

In some embodiments, the solvent comprises hydrochloric acid. In some embodiments, the solvent comprises borax or boric acid. In some embodiments, the solvent comprises methanol, ethanol, or isopropanol. In some embodiments, separating the at least a portion of the solubilized SrF2 from the mixture comprises filtration.

In some embodiments, the mixture comprises ZrO₂. In some embodiments, the method comprises converting at least a portion of a Zr-containing precursor to ZrO₂ in the mixture. In some embodiments, the Zr-containing precursor comprises ZrF₄. In some embodiments, converting the at least a portion of the Zr-containing precursor to ZrO₂ in the mixture comprises heating the mixture at a temperature such that the ZrF₄ is converted to ZrO₂.

### BRIEF DESCRIPTION OF THE FIGURES

The invention will now be described, by way of example only, with reference to the accompanying drawings, in which:

FIG. 1 illustrates an exemplary process for removing Zr-containing compounds from Sr-containing compounds.

FIG. 2 illustrates another exemplary process for removing Zr-containing compounds from Sr-containing compounds.

FIG. 3 illustrates an exemplary system for removing Zr-containing compounds from Sr-containing compounds.

### DETAILED DESCRIPTION

Described are methods and systems for extracting any form of Zr-containing compounds from any form of Sr-containing compounds. These methods may be carried out in an efficient, safe, and environmentally friendly way, without involving expensive and/or toxic chemicals as reagents, such as HF. In some embodiments, the method described herein does not comprise the use of HF. In some embodiments, the purified Sr-containing compounds can be further used in radioisotope power systems.

A solubilization method for removing Zr-containing compounds from Sr-containing compounds may utilize the solubility differences between certain Sr-containing and Zr-containing chemical species in aqueous solution to separate Zr from Sr. In some embodiments, the method comprises separating certain Sr-containing compounds and Zr-containing compounds, wherein the Sr-containing compounds and Zr-containing compounds can be any compounds (e.g., fluoride, oxide, carbonate, etc.) with solubility difference. In some embodiments, the method may further comprise converting at least of a portion Zr-containing precursor(s) in a mixture to a Zr-containing compounds with different (e.g., increased) aqueous solubility compared to the Zr-containing precursor(s). In some embodiments, the method may further comprise converting at least of a portion Sr-containing precursor(s) in a mixture to Sr-containing compounds with different (e.g., decreased) aqueous solubility compared to the Sr-containing precursor(s). In some embodiments, the Zr-containing compound can be in a different chemical form than the Sr-containing compound, provided that the Zr-containing compounds have different aqueous solubility from Sr-containing compounds. For example, in some embodiments, the Zr-containing compound is ZrO₂, and the Sr-containing compound is SrF₂. In some embodiments, the Zr-containing compound is ZrF₄, and the Sr-containing compound is SrF₂. In some embodiments, the Zr-containing compound is ZrF₄, and the Sr-containing compound is SrCO₃.

In some embodiments, the solubilization method comprises (i) converting at least a portion of the elemental zirconium (Zr), the salt of Zr, and/or oxide of Zr to ZrF₄ in the mixture; (ii) converting at least a portion of the elemental strontium (Sr), the salt of Sr, and/or an oxide of Sr to SrF₂ in the mixture; (iii) solubilizing at least a portion of the ZrF₄ and/or the SrF₂ in a solvent to create a solution; and/or (iv) separating at least a portion of the solubilized ZrF₄ and/or at least a portion of the solubilized SrF₂ from the mixture. The method may include any combination of steps (i)-(iv). For example, in some embodiments, the method comprises steps (i), (iii), and (iv). In some embodiments, the method comprises steps (i), (iii), and (iv) and does not comprise step (ii). In some embodiments, the method comprises steps (ii), (iii), and (iv). In some embodiments, the method comprises steps (ii), (iii), and (iv) and does not comprise step (i). In some embodiments, the method comprises steps (i), (ii), (iii), and (iv).

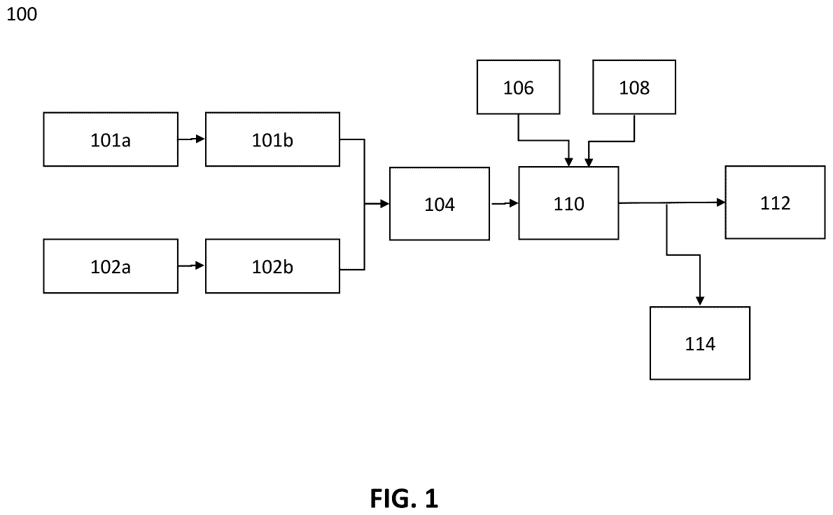

FIG. 1 illustrates an exemplary method 100 for removing elemental Zirconium (Zr), a salt of Zr, and/or oxide of Zr, from a mixture comprising elemental Zr, a salt of Zr, and/or oxide of Zr, and elemental Strontium (Sr), a salt of Sr, and/or an oxide of Sr. Method 100 may also be used for removing Sr from a mixture comprising Zr and Sr. In some embodiments, the method comprises converting at least of a portion Zr-containing precursor(s) 101a to a Zr-containing compound 101b. In some embodiments, the method comprises converting at least a portion of Sr-containing precursor(s) 102a to Sr-containing compound 102b. In some embodiments, the Zr-containing compound 101b has a different solubility, such as different aqueous solubility, compared to the Sr-containing compound 102b. In some embodiments, the Zr-containing compound 101b is zirconium fluoride (ZrF₄) and/or zirconium oxide. In some embodiments, the Sr-containing compound 102b is strontium fluoride (SrF₂). In some embodiments, the converted Zr-containing compound 101b (e.g., ZrF₄) and Sr-containing compound 102b (e.g., SrF₂) can be mixed to form a pre-extraction mixture 104. In some embodiments, converting a Zr-containing precursor (e.g., elemental Zr) to a Zr-containing compound (e.g., ZrF₄) may not be necessary because the Zr-containing compound may already be present at the start of method 100. Similarly, converting an Sr-containing precursor (e.g., elemental Sr) to an Sr-containing compound (e.g., SrF₂) may be unnecessary because the Sr-containing compound may already be present at the start of method 100.

In some embodiments, the Zr-containing precursor(s) 101a can comprise any Zr-containing compounds such as inorganic zirconium salts, organic zirconium salts, non-salt zirconium compounds that include elemental/metallic zirconium, zirconium alloys, zirconium oxides, or combinations thereof. In some embodiments, the Zr-containing precursor(s) comprises a mixture of any two or more Zr-containing compounds, or mixture from different types of Zr-containing compounds (e.g., elemental zirconium and an inorganic zirconium salt).

In some embodiments, the inorganic zirconium salts can include zirconium fluoride, zirconium chloride, zirconium bromide, zirconium iodide, zirconium chlorate, zirconium carbonate, zirconium bicarbonate, zirconium nitrite, zirconium nitrate, zirconium sulfide, zirconium sulfite, zirconium sulfate, zirconium phosphite, zirconium phosphate, zirconium hydroxide, or any combination thereof. In some embodiments, hydrated forms of these inorganic zirconium salts (e.g., zirconium hydroxide monohydrate) can also be used. In some embodiments, the organic zirconium salts can include zirconium acetate, zirconium acetylacetate, zirconium benzoate, strontium citrate, zirconium formate, zirconium oxalate, zirconium salicylate, zirconium tartrate, or any combination thereof.

In some embodiments, the Zr-containing precursor(s) can be a natural mineral comprising Zr-containing compounds. In some embodiments, the Zr-containing precursor(s) comprises elemental/metallic zirconium. In some embodiments, the Zr-containing precursor(s) comprises ZrO₂. In some embodiments, the Zr-containing precursor(s) comprises Zirconium fluoride. In some embodiments, the Zr-containing precursor(s) comprises Zirconium oxyfluorides (ZrOₓF_{y}), such as ZrOF₂. In some embodiments, the Zr-containing precursor(s) can be in the form of a powder. In some embodiments, Zr-containing precursor(s) can be in the form of bulk solid, granule, and/or pellet. In some embodiments, Zr-containing precursor(s) can be in the form of slurry, suspension, and/or dissolved in solution.

In some embodiments, the method may comprise pre-processing steps to obtain Zr-containing precursor(s). In some embodiments, the pre-processing steps may comprise cleaning, grinding, sieving, drying, or any combination thereof.

In some embodiments, the method comprises converting at least a portion (e.g., at least about any of 5 wt. %, 10 wt. %, 20 wt. %, 30 wt. %, 40 wt. %, 50 wt. %, 60 wt. %, 70 wt. %, 80 wt. %, 90 wt. %, 95 wt. %, 99 wt. %, or 100 wt. %) of the Zr-containing precursor(s) 101a to Zr-containing compound 101b (e.g., ZrF₄). In some embodiments, the Zr-containing compound 101b is ZrF₄. In some embodiments, the Zr-containing compound 101b is ZrO₂. In some embodiments, the conversion reaction comprises reacting the Zr-containing precursor(s) with a fluorinating agent, including, but not limited to fluorine gas (F₂), hydrofluoric acid (HF), ammonium bifluoride (NH₄HF), ammonium fluoride (NH₄F), or any combination thereof. In some embodiments, the Zr-containing precursor(s) 101a comprises ZrO₂. In some embodiments, the ZrO₂ can be dissolved in acid to form a more soluble Zr-containing compound 101b. In some embodiments, the ZrO₂ is not converted to ZrF₄.

In some embodiments, the Sr-containing precursor(s) 102a can comprise any Sr-containing compounds such as inorganic strontium salts, organic strontium salts, non-salt strontium compounds that include elemental strontium, strontium alloys, strontium oxides, or any combination thereof. In some embodiments, the Sr-containing precursor(s) comprises a mixture of any two or more Sr-containing compounds, or mixture from different types of Sr-containing compounds (e.g., elemental strontium and an inorganic strontium salt).

In some embodiments, the inorganic strontium salts can include strontium fluoride, strontium chloride, strontium bromide, strontium iodide, strontium chlorate, strontium carbonate, strontium bicarbonate, strontium nitrite, strontium nitrate, strontium sulfide, strontium sulfite, strontium sulfate, strontium phosphite, strontium phosphate, strontium hydroxide, strontium boride (e.g., strontium hexaboride) or any combination thereof. In some embodiments, hydrated forms of these inorganic strontium salts can also be used. In some embodiments, the organic strontium salts can include strontium acetate, strontium acetylacetate, strontium benzoate, strontium citrate, strontium formate, strontium oxalate, strontium salicylate, strontium tartrate, or any combination thereof.

In some embodiments, the Sr-containing precursor(s) can be a natural mineral comprising Sr-containing compounds. In some embodiments, the Sr-containing precursor(s) can contain common Sr-containing minerals, such as Airdite, Aldomarinoite, Arrojadite-(SrFe), Arsenogoyazite, Belovite-(Ce), Belovite-(La), Benauite, Deloneite, Fluorcaphite, Fluorsigaiite, Fluorstrophite, Goedkenite, Goyazite, Grandaite, Gunmaite, Kemmlitzite, Lulzacite, Miyahisaite, Nastrophite, Natropalermoite, Oberwolfachite, Olgite, Palermoite, Stronadelphite, Strontiohurlbutite, Strontioperloffite, Strontiopharmacosiderite, Strontiowhitlockite, Svanbergite, or any combination thereof. In some embodiments, the Sr-containing precursor(s) comprises elemental strontium. In some embodiments, the Sr-containing precursor(s) comprises SrO. In some embodiments, the Sr-containing precursor(s) comprises SrTiO₃, Sr(NO₃)₂, SrSO₄, SrCO₃, SrTi₂O₄, Sr₅(PO₄)₃(OH), Sr₅(PO₄)₃F, or any combination thereof. In some embodiments, the Sr in the Sr-containing precursor(s) 102a comprises ⁸⁴Sr, ⁸⁵Sr, ⁸⁷Sr, ⁸⁸Sr, ⁸⁹Sr, ⁹⁰Sr, ⁹¹Sr, or ⁹²Sr. In some embodiments, the Sr in the Sr-containing precursor(s) 102a comprises ⁹⁰Sr. In some embodiments, at least about 1%, such as at least about any of 1%, 5%, 10%, 15%, 20%, 25%, 30%, 35%, 40%, 45%, 50%, 55%, 60%, 65%, 70%, 75%, 80%, 85%, 90%, 95%, 99%, 99.9%, or 100% of the Sr in the Sr-containing precursor(s) 102a is ⁹⁰Sr. In some embodiments, the Sr-containing precursor(s) can be in the form of a powder.

In some embodiments, the method may comprise a pre-processing step to obtain Sr-containing precursor(s). In some embodiments, the pre-processing step may comprise cleaning, grinding, sieving, drying, or any combination thereof.

In some embodiments, the method comprises converting at least a portion (e.g., at least about any of 5 wt. %, 10 wt. %, 20 wt. %, 30 wt. %, 40 wt. %, 50 wt. %, 60 wt. %, 70 wt. %, 80 wt. %, 90 wt. %, 95 wt. %, 99 wt. %, or 100 wt. %) of the Sr-containing precursor(s) 102a to Sr-containing compound 102b (e.g., SrF₂). In some embodiments, the Sr-containing compound 102b is SrF₂. In some embodiments, the conversion reaction comprises reacting the Sr-containing precursor(s) with a fluorinating agent, including, but not limited to sodium fluoride (NaF), potassium fluoride (KF), fluorine gas (F₂), hydrofluoric acid (HF), ammonium bifluoride (NH₄HF), ammonium fluoride (NH₄F), or any combination thereof.

In some embodiments, the initial reaction mixture comprises SrF₂ and the method does not comprise converting other form of Sr to SrF₂. In some embodiments, the Zr-containing precursor(s) 101a comprises ZrO₂ and the initial reaction mixture comprises SrF₂. In some embodiments, the ZrO₂ and SrF₂ can be mixed with an acid to form a more soluble Zr-containing compound 101b and a less soluble Sr-containing compound 102b.

In some embodiments, the reaction mixture can include a Zr-containing compound (i.e., a Zr-containing precursor) and a Sr-containing compound. In some embodiments, the reaction mixture can include a Zr-containing precursor and a Sr-containing compound. In some embodiments, the initial reaction mixture comprises SrF₂ and ZrF₄. In some embodiments, the Zr-containing precursor 101a may be ZrF₄. In some embodiments, the Zr-containing precursor can be converted to a Zr-containing compound. In some embodiments, the Zr-containing precursor can be converted to a Zr-containing oxide such as ZrO₂. In some embodiments, converting the Zr-containing precursor(s) 101a to Zr-containing compound 101b may include converting ZrF₄ to ZrO₂. In some embodiments, converting the Zr-containing precursor to a Zr-containing compound can include heating the reaction mixture. In some embodiments, ZrF₄ may be converted to ZrO₂ by heating the initial reaction mixture. In some embodiments, the heating may be performed in a kiln. In some embodiments, the heating may be performed at a temperature such that the Zr-containing precursor is converted to a Zr-containing oxide, but the Sr-containing compound is not converted (to a Sr-containing oxide). In some embodiments, the heating may be performed at a low enough temperature such that ZrF₄ is converted to a zirconium oxide (e.g., ZrO₂) but SrF₂ is not converted to a strontium oxide.

In some embodiments, the conversion of Zr-containing precursor(s) 101a to Zr-containing compound 101b (e.g., ZrF₄ or ZrO₂) and/or the conversion of the Sr-containing precursor(s) 102a to Sr-containing compound 102b (e.g., SrF₂) can be done in the same reaction vessel and same reaction mixture 104. In some embodiments, the Zr-containing precursor(s) 101a can be mixed with the Sr-containing precursor(s) 102a before any of the conversions. In some embodiments, the conversion of Zr-containing precursor(s) 101a to Zr-containing compound 101b (e.g., ZrF₄ or ZrO₂) and the conversion of the Sr-containing precursor(s) 102a to Sr-containing compound 102b (e.g., SrF₂) can be done separately in different reaction vessels. In some embodiments, the conversion of Zr-containing precursor(s) 101a to Zr-containing compound 101b (e.g., ZrF₄) can be done in a first reaction vessel, the conversion of the Sr-containing precursor(s) 102a to Sr-containing compound 102b (e.g., SrF₂) can be done in a second reaction vessel, and then the converted Zr-containing compound 101b (e.g., ZrF₄) and Sr-containing compound 102b (e.g., SrF₂) can be subsequently mixed into a mixture 104. In some embodiments, the unconverted Zr-containing precursor(s) can remain the mixture 104. In some embodiments, the unconverted Zr-containing precursor(s) can be separated from the mixture 104. In some embodiments, the unconverted Sr-containing precursor(s) can remain the mixture 104. In some embodiments, the unconverted Sr-containing precursor(s) can be separated from the mixture 104. In some embodiments, in the mixture 104, the molar ratio of SrF₂ to ZrF₄ is at least about any of 1:10000, 1:5000, 1:1000, 1:500, 1:100, 1:50, 1:10, 1:5, 1:1, 5:1, 10:1, 50:1, or 100:1. In some embodiments, in the mixture 104, the molar ratio of SrF₂ to ZrF₄ is no more than about any of 10000:1, 5000:1, 1000:1, 500:1, 100:1, 50:1, 10:1, 5:1, 1:1, 1:5, 1:10, 50:1, or 1:100.

In some embodiments, the mixture 104 can be combined/mixed with a solvent 106 to form a liquid mixture 110. In some embodiments, the solvent 106 can be combined/mixed with the Zr-containing precursor(s) and/or the Sr-containing precursor(s) and therefore remain in the reaction mixture 104. In some embodiments, the mixture 104 can be formed first, and then the solvent 106 can be added into the reaction system.

In some embodiments, solvent 106 may be used to solubilize at least one of the Zr-containing compound 102a (e.g., ZrF₄ or ZrO₂) or the Sr-containing compound 102b (e.g., SrF₂). Solvent 106 may be used to solubilize both the Zr-containing compound 102a and the Sr-containing compound 102b or may be used to solubilize only one of the Zr-containing compound or the Sr-containing compound 102b. For example, solvent 106 may be used to solubilize ZrF₄ but not SrF₂ (or other Sr-containing compound). In some embodiments, the amount of the solvent 106 can be an amount such that at least a portion (e.g., at least about any of 5%, 10%, 20%, 30%, 40%, 50%, 60%, 70%, 80%, 90%, 95%, 99%, or 100%) of the ZrF₄ can be dissolved in the liquid mixture 110. In some embodiments, the amount of the solvent 106 can be an amount such that at least a portion (e.g., at least about any of 5%, 10%, 20%, 30%, 40%, 50%, 60%, 70%, 80%, 90%, 95%, or 99%) of the SrF₂ (or other Sr-containing compound) cannot be dissolved in the liquid mixture 110. In some embodiments, the method comprises solubilizing at least a portion of (e.g., at least about any of 5%, 10%, 20%, 30%, 40%, 50%, 60%, 70%, 80%, 90%, 95%, 99%, or 100%) the ZrF₄ in a solvent to create a solution 110. In some embodiments, the solubilization can be facilitated by stirring or heating. In some embodiments, the solubilization can be carried out in an inert atmosphere. In some embodiments, the inert atmosphere can exclude oxygen. In some embodiments, the inert atmosphere can be an argon atmosphere. In some embodiments, the solubilization can be carried out in air.

In some embodiments, the solvent 106 comprises water and the solution is an aqueous solution. In some embodiments, the solvent 106 is pure water.

In some embodiments, the method may optionally comprise adding a solubility amplifier 108 to the mixture of 110 to increase the solubility differences between Zr-containing compound 101b (e.g., ZrF₄) and Sr-containing compound 102b (e.g., SrF₂) in water. In some embodiments, the method does not comprise adding the solubility amplifier. In some embodiments, without being bound by any scientific theory, the solubility of ZrF₄ in pure water is by an order of magnitude larger than solubility of SrF₂ in pure water under ambient temperature, which could allow separation of ZrF₄ and SrF₂.

In some embodiments, the method comprises adding a solubility amplifier 108 to the mixture of 110. In some embodiments, the solubility amplifier 108 can react with Zr-containing compound 101b (e.g., ZrF₄) to form a Zr-containing species that is at least twice (e.g., at least about any of 3, 5, 8, 10, 15, 20, 30, 40, 50, or 100 times) more soluble than the Zr-containing compound 101b (e.g., ZrF₄) in the solvent 106. In some embodiments, the solubility amplifier 108 can react with the Sr-containing compound 102b (e.g., SrF₂) to form a Sr-containing species that is at least twice (e.g., at least about any of 3, 5, 8, 10, 15, 20, 30, 40, 50, or 100 times) less soluble than Sr-containing compound 102b (e.g., SrF₂) in the solvent 106. In some embodiments, the solubility amplifier 108 increases the solubility differences between ZrF₄ and SrF₂ in water by at least about 1-fold, such as at least about any of 2-fold, 5-fold, 10-fold, 15-fold, 20-fold, 30-fold, 50-fold, 70-fold, 100-fold, or more.

In some embodiments, solvent 106 may be used to solubilize SrF₂ but not ZrF₄, ZrO₂, or any other Zr-containing compound. In some embodiments, the method comprises solubilizing at least a portion of (e.g., at least about any of 5%, 10%, 20%, 30%, 40%, 50%, 60%, 70%, 80%, 90%, 95%, 99%, or 100%) the SrF₂ in a solvent to create a solution 110. In some embodiments, the solubilization can be facilitated by stirring or heating. In some embodiments, the solubilization can be carried out in an inert atmosphere. In some embodiments, the inert atmosphere can exclude oxygen. In some embodiments, the inert atmosphere can be an argon atmosphere. In some embodiments, the solubilization can be carried out in air. In some embodiments, the amount of the solvent 106 can be an amount such that at least a portion (e.g., at least about any of 5%, 10%, 20%, 30%, 40%, 50%, 60%, 70%, 80%, 90%, 95%, 99%, or 100%) of the SrF₂ can be dissolved in the liquid mixture 110. In some embodiments, the amount of the solvent 106 can be an amount such that at least a portion (e.g., at least about any of 5%, 10%, 20%, 30%, 40%, 50%, 60%, 70%, 80%, 90%, 95%, or 99%) of the ZrF₄ (or other Zr-containing compound) cannot be dissolved in the liquid mixture 110.

In some embodiments, solvent 106 may include hydrochloric acid (HCl), borax, and/or boric acid. Optionally, borax and/or boric acid may be added to the HCl. Adding borax and/or boric acid may increase the solubility of SrF₂ in HCl. In some embodiments, solvent 106 may include at least about 4%, 4.5%, 5%, 5.5%, 6%, 6.5%, 7%, or 7.5% borax or boric acid. In some embodiments, solvent 106 may include at most about 8%, 7.5%, 7%, 6.5%, 6%, 5.5%, 5%, or 4.5% borax or boric acid. The HCl may be 6M HCl. In some embodiments, solvent 106 may further include one or more alcohols (e.g., methanol, ethanol, and/or isopropanol) to enhance the solubility of borax or boric acid.

In some embodiments, the method further comprises separating at least a portion of the solubilized Zr-containing compound (e.g., ZrF₄) from the mixture 110 and/or separating at least a portion of solubilized Sr-containing compound (e.g., SrF₂) to form a mixture 112. In some embodiments, the separation can be achieved by any method suitable for separating insolubilized species from solubilized species, including but not limited to, filtration, extraction, or centrifugation, or any combination thereof. In some embodiments, the ratio between the total molar of Sr in all the Sr-containing compounds and the total molar of Zr in all the Zr-containing compounds in mixture 112 is increased by at least about 1-fold, such as at least about any of 2-fold, 5-fold, 10-fold, 15-fold, 20-fold, 30-fold, 50-fold, 70-fold, 100-fold, or more, compared to the ratio in the mixture 110.

In some embodiments, the Zr-containing compound 101b is zirconium fluoride (ZrF₄). In some embodiments, the Sr-containing compound 102b is strontium fluoride (SrF₂). In some embodiments, the solubility amplifier 108 comprises a fluoride salt, such as a fluoride salt of an alkali or alkaline metal. In some embodiments, the alkali metal can be Na, K, Rb, or Cs. In some embodiments, the alkaline can be Mg or Ca. In some embodiments, the solubility amplifier 108 comprises NaF, KF, or a combination thereof. In some embodiments, the solubility amplifier 108 is NaF. In some embodiments, the solubility amplifier 108 is KF. In some embodiments, the weight percentage of the amplifier 108 in the mixture of 110 is about 0.01% to about 15%, such as about any of 0.1% to 10%, 0.1% to 5%, 0.1% to 4%, 0.3% to 10%, or 0.3 to 9%. In some embodiments, the solubility amplifier 108 is NaF, and the weight percentage of the amplifier 108 in the mixture of 110 is about 0.01% to about 15%, such as about any of 0.1% to 10%, 0.1% to 5%, or 0.1% to 4%. In some embodiments, the solubility amplifier 108 is KF, and the weight percentage of the amplifier 108 in the mixture of 110 is about 0.01% to about 15%, such as about any of 0.1% to 10%, 0.3% to 10%, or 0.3% to 9%. In some embodiments, without being bound by any particular scientific interpretation, ZrF₄ can form one or more types of metal fluoride complexes with the solubility amplifier 108, which have higher solubility in water compared to ZrF₄. In some embodiments, without being bound by any particular scientific interpretation, the metal fluoride complexes may include, but are not limited to, NaZrF₅, Na₂ZrF₆, Na₅Zr₂F₁₃, or Na₃ZrF₇, or any combination thereof. In some embodiments, at least a portion (e.g., at least about any of 5%, 10%, 20%, 30%, 40%, 50%, 60%, 70%, 80%, 90%, 95%, or 99%) of SrF₂ remains undissolved in the mixture 110.

In some embodiments, the portion of the solubilized ZrF₄ (or solubilized SrF₂) 114 can be separated from the mixture 110 by any method known in the art capable of separating solid from solution, such as filtration or centrifugation. In some embodiments, the portion of the solubilized ZrF₄ (or solubilized SrF₂) 114 is separated from the mixture 110 by filtration to afford the mixture 112. In some embodiments, mixture 112 is a solid or semi-solid (paste-like) mixture.

In some embodiments, the solubility amplifier 108 comprises a base. In some embodiments, the solubility amplifier 108 increases the pH value of the mixture 110 to a value of at least about 8, such as at least about any of 8.5, 9, 9.5, 10, 10.5, 11, 11.5, 12, 12.5, or 13. In some embodiments, the solubility amplifier 108 comprises NaOH, KOH, NH₄OH, or any combination thereof. In some embodiments, the ZrF₄ has increased solubility in the basic solution achieved by the solubility amplifier 108.

In some embodiments, the solubility amplifier 108 comprises NaF, KF, or a combination thereof, and a base.

In some embodiments, the method comprises solubilizing at least a portion (e.g., at least about any of 5%, 10%, 20%, 30%, 40%, 50%, 60%, 70%, 80%, 90%, 95%, or 99%) of Sr-containing compound 102b (e.g., SrF₂) in the mixture 110 in an organic solvent to create an organic solution. In some embodiments, the method comprises separating at least a portion of the solubilized Zr-containing compound 101b (e.g., ZrF₄) from the organic solution. In some embodiments, the organic solution comprises a halogenated organic solvent, such as CCl₄, CH₃Cl, CHCl₃, trichloroethylene, or any combination thereof. In some embodiments, the organic solvent comprises trichloroethylene (TCE). In some embodiments, the Zr-containing compound 101b is zirconium fluoride (ZrF₄). In some embodiments, the Sr-containing compound 102b is strontium fluoride (SrF₂). In some embodiments, the organic solution with solubilized portion of SrF₂ 112 can be separated from aqueous solution with solubilized ZrF₄ 114 via any method known method in the art capable of separating an organic solution from an aqueous solution, such as extraction. In some embodiments, the organic solution with solubilized portion of SrF₂ 112 can be separated from aqueous solution with solubilized ZrF₄ 114 via extraction to afford the organic solution mixture 112 comprising higher content of Sr.

In some embodiments, the mixture 110 may comprise solubilized SrF₂, and the method may comprise separating at least a portion of the solubilized SrF₂ from the mixture 110. For example, filtration may be used to remove a Zr-rich filter cake from mixture 110, leaving the SrF₂ in the liquid filtrate. In some embodiments, at least about 94%, 94.5%, 95%, 95.5%, 96%, 96.5%, 97%, or 97.5% of the input zirconium may be recovered in the Zr-rich filter cake. In some embodiments, at most about 98%, 97.5%, 97%, 96.5%, 96%, 95.5%, 95%, or 94.5% of the input zirconium may be recovered in the Zr-rich filter cake. As discussed in further detail below, the liquid filtrate may be further processed to isolate strontium from the other components in the liquid filtrate.

In some embodiments, the steps of the methods and processes provided herein may be repeated. For example, in some embodiments, the conversion of the Zr-containing precursor(s) 101a to Zr-containing compound 101b (e.g., ZrF₄) may be repeated to increase the amount of Zr-containing compound 101b (e.g., ZrF₄) in the mixture 104. In some embodiments, the conversion of the Sr-containing precursor(s) 102a to Sr-containing compound 102b (e.g., SrF₂) may be repeated to increase the amount of SrF₂ in the mixture 104. In some embodiments, the solubilization and separation of ZrF₄ may be repeated for at least once (e.g., at least twice, 3 times, 5 times, 10 times, or 100 times) by adding a solvent 106 and optionally a solubility amplifier 108 to the mixture of 112. In some embodiments, the solubilization and separation of ZrF₄ may be repeated until the ratio between the total molar of Sr in all the Sr-containing compounds and the total molar of Zr in all the Zr-containing compounds in final mixture 112 is at least about any of 3:1, 5:1, 10:1, 50:1, 100:1, 500:1, 1000:1, 5000:1, or 10000:1. It should be noted that when the extraction process is repeated, then each extraction cycle can be independently designed and selected. For example, in some embodiments, the first extraction cycle may comprise solubilizing ZrF₄ by adding NaF as a solubility amplifier, and then filtering the solution to afford solid mixture 112, and the second extraction cycle may comprise solubilizing ZrF₄ by adding NaOH as a solubility amplifier, adding an organic solution to extracted SrF₂ from the mixture, and the separate the organic solution to afford mixture 112. In some embodiments, when the extraction process is repeated, each extraction cycle can involve the same chemical reactions and/or chemical processes.

In some embodiments, the insolubilized Sr-containing compound may be further recycled to extract more Sr-containing species. For example, in some embodiments, the insolubilized Sr-containing compound may be digested by acidic solution, optionally at an elevated temperature (e.g., at least about 30° C., 35° C., 40° C., 45° C., 50° C., 55° C., 60° C., 65° C., 70° C., 75° C., or 80° C.). In some embodiments, the digested mixture can be filtered and the filtrate can be further mixed with a base (e.g., NaOH, KOH, NaHCO₃, KHCO₃) to form a basic mixture. In some embodiments, the pH of the basic mixture can be tuned to about 7 to about 13, about 8 to about 12, about 9 to about 10, about 9, or about 10. In some embodiments, this basic mixture can be further digested at an elevated temperature (e.g., at least about 30° C., 35° C., 40° C., 45° C., 50° C., 55° C., 60° C., 65° C., 70° C., 75° C., or 80° C.) to further extract Sr-containing species.

In some embodiments, solubilized SrF₂ may be further processed to extract Sr from solution. For example, an HCl and borax or boric acid-containing solution may be used to solubilize SrF₂ in a mixture 110 as described above. The zirconium may be filtered out, leaving the solubilized SrF₂ in the liquid filtrate. The filtrate may be treated with ammonium hydroxide, sodium hydroxide, and/or potassium hydroxide to form a slurry with a pH of about 1-3. Ammonium carbonate, sodium carbonate, and/or potassium carbonate may be added to increase the pH to about 9-11, or about 9.5. In some embodiments, the filtrate is not treated with ammonium hydroxide, sodium hydroxide, and/or potassium hydroxide and instead is treated only with ammonium carbonate, sodium carbonate, and/or potassium carbonate. The slurry may be filtered to remove strontium solids (e.g., as strontium carbonate). In some embodiments, at least about 95%, 95.5%, 96%, 96.5%, 97%, 97.5%, 98%, or 98.5% of the input strontium may be recovered. In some embodiments, at most about 99%, 98.5%, 98%, 97.5%, 97%, 96.5%, 96%, or 95.5% of the input strontium may be recovered. The strontium solids can then be converted to another form of strontium by any method disclosed in the art and/or described herein. For example, strontium carbonate can then be converted to SrF₂ by any of the methods disclosed herein.

In some embodiments, the mixture 112 could be further processed to produce Sr-containing materials suitable for practical applications, particularly in radioisotope power systems. In some embodiments, the method further comprises drying the mixture 112 to obtain solid form SrF₂. In some embodiments, the drying can be done at an elevated temperature, such as at least about any of 70° C., 100° C., 150° C., 200° C., 250° C., or 300° C. In some embodiments, the solid form SrF₂ may be further grinded to achieve desirable particle sizes and/or particle size distributions.

In some embodiments, the method comprises: (i) solubilizing at least a portion of ZrF₄ and SrF₂ in water, and (ii) separating at least a portion of the solubilized ZrF₄.

In some embodiments, the method comprises: (i) solubilizing at least a portion of ZrF₄ and SrF₂ in water comprising KF, and (ii) separating at least a portion of the solubilized ZrF₄.

In some embodiments, the method comprises: (i) solubilizing at least a portion of ZrO₂ and/or SrF₂ in acidic solution, (ii) separating at least a portion of undissolved solid from the solution; (iii) extracting Sr-containing species (e.g., SrF₂ or SrCO₃) from the undissolved solid.

In some embodiments of the foregoing, the method comprises converting at least portion of elemental Sr, or an oxide of Sr to SrCO₃, and converting the SrCO₃ to SrF₂.

Another approach provided herein is a sublimation method for removing Zr-containing materials from Sr-containing materials, which utilizes the different sublimation temperatures of certain Sr-containing and Zr-containing chemical species to isolate Zr from Sr. In some embodiments, the sublimation method comprises (i) converting the elemental Zr, the salt of Zr, and/or oxide of Zr to ZrF₄ and/or ZrCl₄ in the mixture; and (ii) subliming at least a portion of the ZrF₄ and/or ZrCl₄ from the mixture. In some embodiments, the methods provided herein can be used to purify Sr-containing chemical species at a large scale, such as at a scale of mg, g, kg, tens of kg, hundreds of kg, or tons. In some embodiments, due to the low sublimation temperature of the Zr-containing chemical species described herein, the method is efficient, cost-effective, and environmentally friendly.

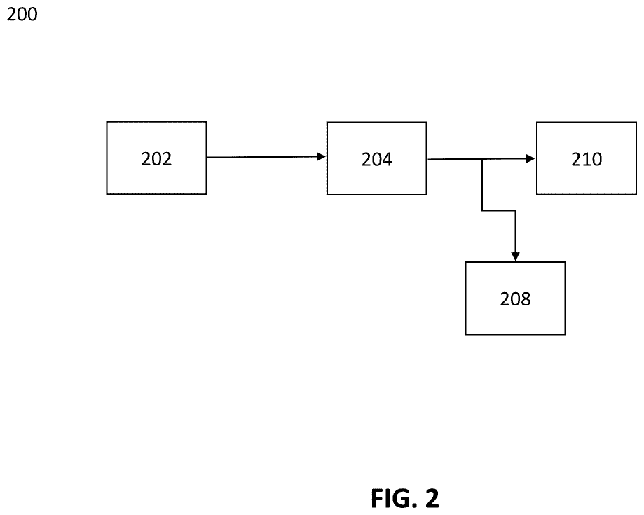

FIG. 2 illustrates another exemplary process 200 for removing elemental zirconium (Zr), a salt of Zr, and/or oxide of Zr, from a mixture comprising elemental Zr, a salt of Zr, and/or oxide of Zr, and elemental strontium (Sr), a salt of Sr, and/or an oxide of Sr.

In some embodiments, the method comprises converting at least of a portion (e.g., at least about any of 5 wt. %, 10 wt. %, 20 wt. %, 30 wt. %, 40 wt. %, 50 wt. %, 60 wt. %, 70 wt. %, 80 wt. %, 90 wt. %, 95 wt. %, 99 wt. %, or 100 wt. %) of Zr-containing precursor(s) 202 to zirconium halide 204 in the mixture. In some embodiments, the Zr-containing precursor(s) 202 can comprise any of the Zr-containing compounds described previously. In some embodiments, Zr-containing precursor(s) 202 can comprise elemental Zr, the salt of Zr, or oxide of Zr, or any combination thereof. In some embodiments, the Zr-containing precursor(s) can be a natural mineral comprising Zr-containing compounds.

In some embodiments, the method comprises converting at least of a portion (e.g., at least about any of 5 wt. %, 10 wt. %, 20 wt. %, 30 wt. %, 40 wt. %, 50 wt. %, 60 wt. %, 70 wt. %, 80 wt. %, 90 wt. %, 95 wt. %, 99 wt. %, or 100 wt. %) of Zr-containing precursor(s) 202 to ZrF₄ 204 in the mixture, using any of the conversion methods provided herein. In some embodiments, the method comprises subliming at least of a portion (e.g., at least about any of 5%, 10%, 20%, 30%, 40%, 50%, 60%, 70%, 80%, 90%, 95%, 99%, or 100%) of ZrF₄ 208 in the mixture to afford a final mixture 210. In some embodiments, the sublimation of a portion of the of ZrF₄ 208 is carried out at a temperature from about 500° C. to about 1100° C., such as about 500° C. to about 900° C. or about 800° C. to about 900° C. In some embodiments, the sublimation can be aided by reducing pressure, such as subjecting the sublimation system to vacuum. In some embodiments, the sublimation is carried out below about 10 psi, such as below about any of 9 psi, 8 psi, 7 psi, 6 psi, 5 psi, 4 psi, 3 psi, 2 psi, 1 psi, 0.5 psi, or 0.1 psi.

In some embodiments, the zirconium halide 204 is ZrCl₄. In some embodiments, the method comprises converting at least a portion of elemental Zr to ZrCl₄ in the mixture. In some embodiments, the conversion of elemental Zr to ZrCl₄ comprises reacting Zr with a mixture of FeCl₃ and optionally KCl. In some embodiments, the method comprises converting at least a portion of an oxide of Zr to ZrCl₄ in the mixture. In some embodiments, the oxide is ZrO₂. In some embodiments, the conversion of Zr oxide (e.g., ZrO₂) to ZrCl₄ comprises reacting Zr oxide (e.g., ZrO₂) with CCl₄ at an elevated temperature of about 300° C. to about 650° C., such as a temperature of about any of 300° C. to 600° C., 350° C. to 550° C., or 380° C. to 550° C. In some embodiments, the method comprises converting at least a portion of a zirconium salt to ZrCl₄ in the mixture. In some embodiments, the zirconium salt may comprise ZrF₄. In some embodiments, the conversion of ZrF₄ to ZrCl₄ comprises reacting ZrF₄ with a mixture of FeCl₃ and KCl. In some embodiments, the method comprises subliming at least of a portion (e.g., at least about any of 5%, 10%, 20%, 30%, 40%, 50%, 60%, 70%, 80%, 90%, 95%, 99%, or 100%) of ZrCl₄ 208 in the mixture to afford a final mixture 210. In some embodiments, the sublimation of a portion of the of ZrCl₄ 208 is carried out at a temperature from about 500° C. to about 900° C., such as about 300° C. to about 400° C.

In some embodiments, the steps of the methods and processes provided herein may be repeated. For example, in some embodiments, the conversion of the Zr-containing precursor(s) 202 to ZrCl₄ 204 may be repeated to increase the amount of ZrCl₄ in the mixture 204. In some embodiments, the process may be repeated until the ratio between the total molar of Sr in all the Sr-containing compounds and the total molar of Zr in all the Zr-containing compounds in final mixture 210 is at least about any of 5:1, 10:1, 50:1, 100:1, 500:1, 1000:1, 5000:1, or 10000:1. In some embodiments, when the extraction process is repeated, each extraction cycle is independently selected. In some embodiments, when the extraction process is repeated, each extraction cycle can use the same chemical reactions and/or chemical processes.

In some embodiments, the method may further comprise post-processing steps, such as drying, grinding, chemical reactions, or any other processes necessary for preparing Sr-containing compounds suitable for radioisotope power generation. In some embodiments, the post-processing comprises grinding, such as ball milling, wetting or drying, sieving into certain particle size distribution, or any combination thereof.

Another approach provided herein is a melting method for removing Zr-containing materials from Sr-containing materials. In some embodiments, the Zr-containing materials can be melted and separated from Sr-containing materials. In some embodiments, the Sr-containing materials can be melted and separated from Zr-containing materials. In some embodiments, the separation can be carried out by centrifugation. In some embodiments, the separation can be carried out by filtration.

Alternatively, Zr-containing materials may be removed from Sr-containing materials via ion exchange. In an ion exchange separation, compounds are separated based on their net charge. For example, a positively charged compound may be adsorbed and retained by an ion exchanger having a negative charge in an ion exchange column, while a negatively charged compound may be eluted from the column. In some embodiments, ion exchange techniques may be used in combination with the solubility separation techniques disclosed herein (e.g., as a separation step to remove solubilized SrF₂ or ZrF₄ from a mixture). In some embodiments, ion exchange techniques may be used as an alternative to the solubility separation techniques described herein.

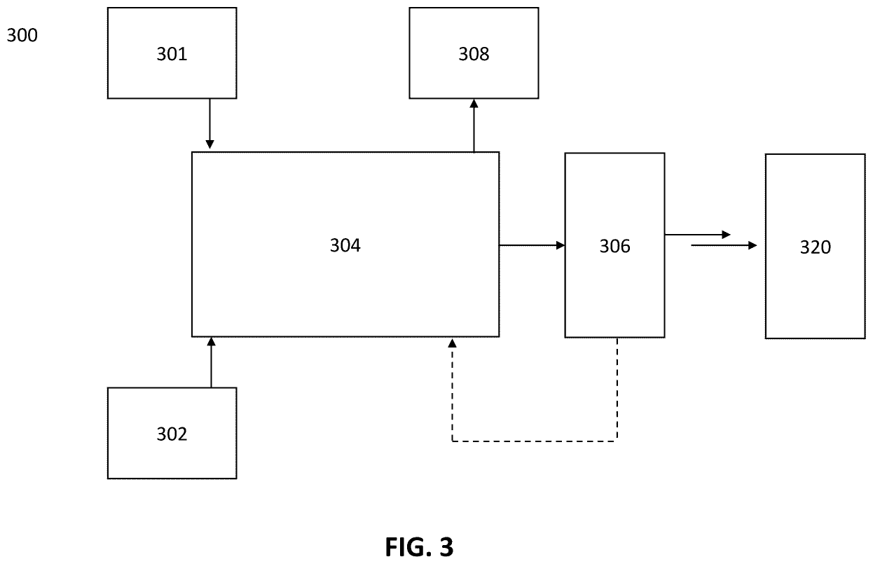

FIG. 3 illustrates an exemplary reaction system 300 to carry out the processes illustrated herein. In some embodiments, the reaction system 300 can comprise a zirconium processing unit 301, wherein the Zr-containing precursor(s) can be processed and converted to a zirconium halide, such as ZrF₄ or ZrCl₄. In some embodiments, the reaction system 300 can comprise a strontium processing unit 302, wherein the Sr-containing precursor(s) can be processed and optionally converted to a strontium halide, such as SrF₂. In some embodiments, the zirconium processing unit 301 and strontium processing unit 302 may also carry out other pre-processing steps, such as cleaning, grinding, sieving, drying, or any combination thereof.

In some embodiments, the zirconium processing unit 301 and strontium processing unit 302 are connected, such as fluidically connected to the reactor 304. In some embodiments, the Zr-containing compounds and Sr-containing compounds after pre-processing can be mixed in the reactor 304. In some embodiments, the reactor can comprise an inlet configured to receive a solvent or other chemicals needed for the solubilization process. In some embodiments, the reactor 304 is configured such that the solubilization and separation process described herein can be carried out efficiently. For example, the reactor 304 may comprise a stirring unit such that the Zr-containing compound (e.g., ZrF₄) can be efficiently mixed with and dissolved in the solvent with the solubility amplifier. In some embodiments, the reactor 304 may comprise a stirring unit such that the Sr-containing compound (e.g., SrF₂) can be efficiently mixed with and dissolved in a solvent. In some embodiments, the reactor 304 may further comprise a filtration unit and/or a centrifugation unit, such that the undissolved Zr-containing compound (e.g., zirconium oxide and/or ZrF₄) can be separated from the solution. In some embodiments, the reactor 304 may further comprise a filtration unit and/or a centrifugation unit, such that the undissolved Sr-containing compound (e.g., SrF₂) can be separated from the solution. In some embodiments, the reactor can comprise a heater, such as a heater for sublimation. In some embodiments, the reactor 304 is configured such that the sublimation process described herein can be carried out efficiently. In some embodiments, the reactor may further comprise a solid mixer, such that the solid from the zirconium processing unit 301 and strontium processing unit 302 can be thoroughly mixed. In some embodiments, the reactor may comprise a cooler, such that the heat generated and released from the solubilization and/or separation process can be removed. In some embodiments, the reactor 304 may be operated under/in an inert and/or a controlled atmosphere, such as an oxygen-free atmosphere. In some embodiments, the reactor 304 may be operated under/in ambient conditions without special control of oxygen content. In some embodiments, the reactor 304 may be flowed with reactive gas (e.g., F₂ or CCl₄).

In some embodiments, the reactor can comprise an outlet configured to discharge Zr-containing compounds, such as Zr-containing compounds in the form of solution, gas, or solid powder, from the reactor 304. In some embodiments, depending on the density of the Zr-containing compounds to be discharged, the outlet can be on the top or the bottom of the reactor 304. In some embodiments, the discharged Zr-containing compounds may be collected in a Zr collection unit 308. In some embodiments, the remaining Sr-containing compounds (in the form of solution, gas, or solid powder) can be optionally transferred to a storage unit 306. In some embodiments, the storage unit 306 is designed such that Sr-containing compounds, such as SrF₂ can be stored for a short-term or long-term storage without oxidation or degradation. In some embodiments, for example, the storage unit 306 comprises a desiccant to remove moisture from the Sr-containing compounds. In some embodiments, for another example, the storage unit 306 comprises a temperature controller to control the temperature of the storage unit. In some embodiments, the Sr-containing compounds in the storage unit 306 may be fed back to the reactor 304 to repeat the extraction cycles. In some embodiments, the Sr-containing compounds in the storage unit 306 may be further processed before being fed into a radioisotope power system 320. For example, in some embodiments, the Sr-containing compounds in the storage unit 306 may be further fed into a post-processing unit, which can carry out further drying, grinding, chemical reactions, or any other processes necessary for preparing Sr-containing compounds suitable for radioisotope power generation. In some embodiments, the post-processing comprises grinding, such as ball milling, wetting or drying, sieving into certain particle size distribution, or any combination thereof.

The methods and systems discussed above focus on removal of zirconium from a mixture including zirconium and strontium, but it should be understood that the systems and methods described herein can be used to remove other impurities from such a mixture. For example, the systems and methods described herein can be used to remove other impurities such as aluminum, barium, calcium, cadmium, cobalt, chromium, cesium, copper, iron, potassium, magnesium, manganese, sodium, neodymium, nickel, lead, yttrium, silicon, and carbon from such a mixture. In some embodiments, impurities may be included in a filtrate or waste stream from a zirconium or strontium separation, and the filtrate or waste stream may be further processed to isolate one or more of the impurities from the filtrate or waste stream.

### EXAMPLES

The following examples are presented for purposes of illustration, and are not intended to impose limitations on the scope of this disclosure.

### Example 1. Solubility Separation of ZrF₄ from SrF₂

To a reaction vessel containing about 30 g ZrF₄ and SrF₂ powder, 100 mL pure water and about 1 g NaF are added, and the reaction mixture is stirred under ambient temperature for about 30 minutes. Then the reaction mixture is vacuum filtered through a Buchner or Hirsch Funnel. The solid is collected and stored for future use.

### Example 2. Solubility Separation of ZrF₄ from SrF₂

To a reaction vessel containing 10 g ZrF₄ and SrF₂ powder, 100 mL pure water and about 6 g NaF are added. NaOH is also added to titrate the reaction mixture to have a pH of more than 7. The reaction mixture is then stirred under ambient temperature. Then 50 mL trichloroethylene is added to the reaction vessel, and the entire mixture is transferred to a separatory funnel. The separatory funnel is shook thoroughly and set aside until two layers of solutions are formed. The denser solution is collected and the organic solvent is further removed by a rotary evaporator. The solid is collected and stored for future use.

### Example 3. Solubility Separation of SrF₂ from ZrO₂

To a reaction vessel containing about 4 g SrF₂ and ZrO₂ powders in mass ratio 2:1, 100 ml of acid is added. The mixture is stirred at elevated temperatures, such as 90° C. for several hours. The reaction mixture is filtered, and the undissolved part of the mixture is recovered after firing at about 900° C. for several hours and undergoes recycling to extract more Sr, such as by following the steps detailed in Example 4. The liquid part of the reaction mixture (filtrate solution) undergoes reconstitution of SrF₂. NaF is added to the filtrate in the 5% molar excess of the amount of fluoride in the starting SrF₂ and ZrO₂ powder blend. The pH of this solution is increased to 8-10 by adding 10 M NaOH. After stirring for about 15 minutes, insoluble material is separated from liquid by filtration. Solid is recovered by firing at about 900° C. for several hours.

### Example 4. Recycling Route of Undissolved Solid in Example 3

The undissolved part of the mixture from Example 3 undergoes digestion in acidic solution at elevated temperatures and is filtered again. The pH of the filtrate is adjusted by 3M KHCO₃ to neutral, and then to 9-10 by 5 M K₂CO₃. This reaction mixture is digested at 80° C. for a couple of hours and filtered. Solid is recovered after firing at about 900° C. for several hours.

### Example 5. Solubility Separation of SrF₂ from ZrO₂ Using Borax

A reaction vessel is charged with 15 g of SrF₂ and ZrO₂ powders in a 2:1 mass ratio and 125 mL of 4.8% w/v borax in 6M HCl. The resulting slurry is heated to 50° C. with stirring for 60 minutes. The slurry is cooled to 25° C. and filtered to remove zirconium solids. The filter cake is washed with 45 mL of 4% w/v borax in 6M HCl and dried. The dried filter cake includes about 94-98% of the input ZrO₂.

Pure boric acid may be substituted for borax. Up to 8% borax was tested as effective; values less than 4% may be less effective. Lower volumes of 6M HCl may reduce strontium recovery. The temperature may vary; lower temperatures may require longer times. Alcohols (such as methanol, ethanol, isopropanol, etc.) may be added to the system to improve boric acid solubility, but are not necessary for this exemplary use.

### Example 6. Recovery of Strontium from Acidic Borax Solutions

The filtrate and wash from the boric acid in 6M HCl treatment (˜170 mL) from Example 5 is charged to a reaction vessel and treated with 35% ammonium hydroxide solution until the pH is about 1-3. A controlled addition of 3M ammonium carbonate is performed until the pH is about 9.5. The solution is then heated to reflux at about 70° C. and stirred for about 60 minutes. The solution is then cooled to about 25° C. The solution is then filtered, and the resulting filter cake is washed three times with 30 mL of water. The filter cake includes about 95-99% of the input strontium as strontium carbonate.

The initial titration to pH 1-3 is undetermined, but higher pH values in the absence of carbonate can induce strontium hydroxide formation, which may be both irreversible and undesirable. Ammonium hydroxide may be substituted with sodium hydroxide or potassium hydroxide. Ammonium hydroxide may be omitted, and only ammonium carbonate may be used, although the initial reactions are foamy and the overall solution volumes become much greater. Sodium carbonate or potassium carbonate (or bicarbonate) may be used in place of ammonium carbonate, but with greater potential for sodium or potassium contamination of the product cake. The time and temperature of heating is unknown and may not be necessary. The ideal pH is undetermined, but recoveries appear to diminish when pH<9. Most borax from the initial dissolution is removed by this process.

### Example 7. Sublimation Method for Solid Containing ZrO₂

Reaction vessel containing 1 to 2 g solid comprising ZrO₂ and at least one Sr-containing compound is exposed to a nitrogen and CCl₄ gas mixture with CCl₄ partial pressure from 0.2 to 0.6 atm for up to 1 hour at a temperature of about 377° C. to about 552° C. to form ZrCl₄. The solid mixture is then heated up to 331° C. under ambient pressure. The gas phase is released from the reaction system. The remaining solid is collected and stored for future use.

### Example 8. Sublimation Method for Solid Containing ZrF₄

To a reaction vessel containing 1 g solid comprising ZrF₄ and at least one Sr-containing compound, 1.3 g FeCl₃ is added together with KCl and mixed with the solid under stirring. Remaining FeCl₂ or FeCl₃ and KCl that are in solids phase can be removed by dissolution in water to separate from Sr-containing compound insoluble in water (such as SrF₂). The solid mixture is then subject to heated up to 331° C. under ambient pressure. The gas phase is released from the reaction system. The remaining solid is collected and stored for future use.

### Embodiments

Embodiment 1. A method for removing elemental Zirconium (Zr), a salt of Zr, or oxide of Zr, from a mixture comprising elemental Zr, a salt of Zr, or oxide of Zr, and elemental Strontium (Sr), a salt of Sr, or an oxide of Sr, comprising: converting at least a portion of the elemental Zirconium (Zr), the salt of Zr, or oxide of Zr to ZrF₄ in the mixture; or converting at least a portion of the elemental Strontium (Sr), the salt of Sr, or an oxide of Sr to SrF₂ in the mixture; solubilizing at least a portion of the ZrF₄ in a solvent to create a solution; and separating at least a portion of the solubilized ZrF₄ from the mixture.

Embodiment 2. The method of embodiment 1, wherein the solvent comprises water and the solution is an aqueous solution.

Embodiment 3. The method of embodiment 2, wherein the solubilization of at least a portion of the ZrF₄ comprises adding at least one solubility amplifier to the mixture to increase the solubility differences between ZrF₄ and SrF₂ in water.

Embodiment 4. The method of embodiment 3, wherein the solubility amplifier comprises NaF, KF, or a combination thereof.

Embodiment 5. The method of embodiment 4, wherein the portion of the solubilized ZrF₄ is separated from the mixture by filtration.

Embodiment 6. The method of embodiment 3, wherein the solubility amplifier comprises a base.

Embodiment 7. The method of embodiment 3 or 6, wherein the solubility amplifier comprises NaOH, KOH, NH₄OH, or any combination thereof.

Embodiment 8. The method of embodiment 7, comprising: solubilizing at least a portion of SrF₂ in an organic solvent to create an organic solution; and separating at least a portion of the solubilized ZrF₄ from the organic solution.

Embodiment 9. The method of embodiment 8, wherein the organic solvent comprises halogenated organic solvent.

Embodiment 10. The method of embodiment 9, wherein the halogenated organic solvent comprise trichloroethylene (TCE).

Embodiment 11. The method of any of embodiments 1-10, wherein the mixture comprises ZrO₂.

Embodiment 12. The method of any of embodiments 1-11, wherein the mixture comprises ZrF₄.

Embodiment 13. The method of any of embodiments 1-12, wherein the mixture comprises elemental Zr.

Embodiment 14. The method of any of embodiments 1-13, wherein the conversion of at least a portion of the elemental Zr, the salt of Zr, or oxide of Zr to ZrF₄ in the mixture comprises reacting the elemental Zr, the salt of Zr, or oxide of Zr with a fluorinating agent.

Embodiment 15. The method of embodiment 14, wherein the fluorinating agent comprises fluorine gas (F₂), hydrofluoric acid (HF), ammonium bifluoride (NH₄HF), ammonium fluoride (NH₄F), or any combination thereof.

Embodiment 16. The method of any of embodiments 1-15, wherein the mixture comprises strontium hexaboride SrB₆.

Embodiment 17. The method of any of embodiments 1-16, wherein the mixture comprises SrTiO₃, Sr(NO₃)₂, SrSO₄, or SrCO₃.

Embodiment 18. The method of any of embodiments 1-17, wherein the mixture comprises elemental Sr.

Embodiment 19. The method of any of embodiments 1-18, wherein the mixture comprises SrF₂.

Embodiment 20. The method of any of embodiments 1-19, wherein the conversion of at least a portion of the elemental Sr, the salt of Sr, or oxide of Sr to SrF₂ in the mixture comprises reacting the elemental Sr, the salt of Sr, or oxide of Sr with a fluorinating agent.

Embodiment 21. The method of embodiment 20, wherein the fluorinating agent comprises sodium fluoride (NaF), potassium fluoride (KF), fluorine gas (F₂), hydrofluoric acid (HF), ammonium bifluoride (NH₄HF), ammonium fluoride (NH₄F), or any combination thereof.

Embodiment 22. The method of embodiment 20, comprising converting at least portion of elemental Sr, or an oxide of Sr to SrCO₃, and converting the SrCO₃ to SrF₂.

Embodiment 23. The method of embodiment 1, wherein the mixture comprises ZrO₂, and the method comprises converting at least a portion of the elemental Strontium (Sr), the salt of Sr, or an oxide of Sr to SrF₂ in the mixture, and separating at least a portion of the ZrO₂ from the mixture.

Embodiment 24. A method for removing elemental Zirconium (Zr), a salt of Zr, or oxide of Zr, from a mixture comprising elemental Zr, a salt of Zr, or oxide of Zr, and elemental Strontium (Sr), a salt of Sr, or an oxide of Sr, comprising: converting the elemental Zr, the salt of Zr, or oxide of Zr to ZrF₄ or ZrCl₄ in the mixture; and subliming at least a portion of the ZrF₄ or ZrCl₄ from the mixture.

Embodiment 25. The method of embodiment 24, comprising converting the elemental Zr, the salt of Zr or oxide of Zr to ZrCl₄.

Embodiment 26. The method of embodiment 24 or 25, comprising converting Zr oxide to ZrCl₄.

Embodiment 27. The method of embodiment 26, wherein the conversion of Zr oxide to ZrCl₄ comprises reacting Zr oxide with CCl₄ at an elevated temperature of about 350° C. to about 600° C.

Embodiment 28. The method of embodiment 24 or 25, comprising converting the elemental Zr, the salt of Zr or oxide of Zr to ZrF₄ and then converting ZrF₄ to ZrCl₄.

Embodiment 29. The method of embodiment 28, wherein the conversion of ZrF₄ to ZrCl₄ comprises reacting ZrF₄ with a mixture of FeCl₃ and KCl.

Embodiment 30. The method of embodiment 24 or 25, wherein the conversion of elemental Zirconium (Zr), the salt of Zr or oxide of Zr to ZrF₄ comprises converting elemental Zr to ZrCl₄.

Embodiment 31. The method of embodiment 30, wherein the conversion of Zr to ZrCl₄ comprises reacting Zr with a mixture of FeCl₃ and KCl.

Embodiment 32. The method of any one of embodiments 24-31, wherein the sublimation of a portion of the of ZrF₄ or ZrCl₄ is carried out at a temperature from about 250° C. to about 900° C.

Embodiment 33. The method of any one of embodiments 24-32, wherein the sublimation is carried out at a temperature from about 300° C. to about 400° C.

Embodiment 34. The method of any one of embodiments 24-33, wherein the sublimation is carried out under a pressure lower than ambient pressure.

Embodiment 35. The method of any one of embodiments 24-34, wherein the sublimation is carried out under a pressure of less than 10 psi.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. The theories put forth in this specification, and unless expressly stated otherwise, in no way limit, restrict or narrow the scope of protection to be afforded the claimed inventions. These theories may not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, for example, the configurations provided in the various embodiments of this specification may be used with each other; and the scope of protection afforded the present inventions should not be limited to a particular embodiment, configuration or arrangement that is set forth in a particular embodiment, example, or in an embodiment in a particular figure.

As used in the present specification, the following words and phrases are generally intended to have the meanings as set forth below, except to the extent that the context in which they are used indicates otherwise.

As used herein and in the appended claims, the singular forms “a”, “an” and “the” include plural forms, unless the context clearly dictates otherwise.

As used herein, and unless otherwise specified, the terms “about” and “approximately,” when used in connection with doses, amounts, or weight percent of ingredients of a composition or a dosage form, mean a dose, amount, or weight percent that is recognized by those of ordinary skill in the art to provide a pharmacological effect equivalent to that obtained from the specified dose, amount, or weight percent. Specifically, where applicable, the terms “about” and “approximately,” when used in this context, contemplate a dose, amount, or weight percent within 15% of the specified dose, amount, or weight percent.

It is understood that embodiments described herein as “comprising” include “consisting of” and “consisting essentially of” embodiments.

1. A method for removing zirconium (Zr) from a mixture comprising Zr and strontium (Sr), comprising:
converting at least a portion of a Zr-containing precursor to ZrF₄ in the mixture;
solubilizing at least a portion of the ZrF₄ in a solvent to create a solution; and
separating at least a portion of the solubilized ZrF₄ from the mixture.

2. The method of claim 1, wherein the Zr-containing precursor comprises elemental zirconium, a salt of zirconium, or an oxide of zirconium.

3. The method of claim 1, comprising converting at least a portion of a Sr-containing precursor in the mixture to SrF₂.

4. The method of claim 3, wherein the Sr-containing precursor is elemental strontium, a salt of strontium, or an oxide of strontium.

5. The method of claim 4, wherein converting at least a portion of the Sr-containing precursor in the mixture to SrF₂ comprises reacting the Sr-containing precursor with a fluorinating agent.

6. (canceled)

7. The method of claim 5, comprising converting at least portion of the Sr-containing precursor to SrCO₃, and converting the SrCO₃ to SrF₂.

8. (canceled)

9. The method of claim 1, wherein solubilizing at least a portion of the ZrF₄ comprises adding at least one solubility amplifier to the mixture to increase a solubility difference between ZrF₄ and SrF₂ in water.

10.-12. (canceled)

13. The method of claim 1, further comprising solubilizing at least a portion of SrF₂ in an organic solvent to create an organic solution; and
separating at least a portion of the solubilized ZrF₄ from the organic solution.

14.-15. (canceled)

16. The method of claim 1, wherein separating the at least a portion of the solubilized ZrF₄ from the mixture comprises filtration.

17.-18. (canceled)

19. The method of claim 1, wherein the mixture comprises ZrO₂, and the method comprises converting at least a portion of the Sr-containing precursor to SrF₂ in the mixture, and separating at least a portion of the ZrO₂ from the mixture.

20. A method for removing zirconium (Zr) from a mixture comprising Zr and strontium (Sr), comprising:
converting a Zr-containing precursor to ZrF₄ or ZrCl₄ in the mixture; and
subliming at least a portion of the ZrF₄ or ZrCl₄ from the mixture.

21.-24. (canceled)

25. The method of claim 20, comprising converting the Zr-containing precursor to ZrF₄ and then converting ZrF₄ to ZrCl₄.

26.-32. (canceled)

33. A method for removing strontium (Sr) from a mixture comprising zirconium (Zr) and Sr, comprising:
solubilizing at least a portion of SrF₂ in the mixture in a solvent to create a solution; and
separating at least a portion of the solubilized SrF₂ from the mixture.

34. The method of claim 33, comprising converting at least a portion of an Sr-containing precursor to SrF₂ in the mixture prior to solubilizing the at least a portion of the SrF₂.

35. (canceled)

36. The method of claim 33, further comprising converting the solubilized SrF₂ to a Sr-containing solid.

37. The method of claim 36, wherein converting the solubilized SrF₂ to the Sr-containing solid comprises treating the solubilized SrF₂ with ammonium carbonate, sodium carbonate, and/or potassium carbonate.

38. The method of claim 36, further comprising removing the Sr-containing solid from remaining solubilized materials.

39.-40. (canceled)

41. The method of claim 39, comprising converting at least portion of the Sr-containing precursor to SrCO₃, and converting the SrCO₃ to SrF₂.

42. The method of claim 33, wherein the solvent comprises hydrochloric acid, borax, boric acid, methanol, ethanol, or isopropanol.

43.-44. (canceled)

45. The method of claim 33, wherein separating the at least a portion of the solubilized SrF₂ from the mixture comprises filtration.

46.-49. (canceled)
